(19) United States
(12) Patent Application Publication
(10) Pub. No.: US 2026/0330499 A1
(43) Pub. Date: Oct. 22, 2026

(54) Privacy-Preserving Advertising Verification and Attribution Systems and Methods

(71) Applicant: Yana Kolesnik, Munich (DE)

(72) Inventor: Yana Kolesnik, Munich (DE)

(21) Appl. No.: 19/392,978

(22) Filed: Nov. 18, 2025

(51) Int. Cl. G06Q 30/0241; H04L 9/00; H04L 9/32

(52) U.S. Cl. CPC G06Q 30/0248; H04L 9/3239; H04L 9/3247; H04L 9/50

(57) ABSTRACT

A system and method for privacy-preserving verification and attribution of digital advertising content are disclosed. The system authenticates digital creatives through cryptographic provenance validation and multimodal deepfake detection, and issues a Verified Media Certificate binding a content hash and consent token. Attribution is performed using secure computation and differential privacy to prevent disclosure of user-level data. Zero-knowledge proofs verify that authenticity constraints, privacy mechanisms, and privacy-budget limits were correctly enforced. All proofs, parameters, and authenticity attestations are stored in a hash-chained audit ledger, providing end-to-end technical assurance of authenticity, privacy, and auditability.

### CROSS-REFERENCE TO RELATED APPLICATIONS

None.

### FIELD OF THE INVENTION

The invention concerns digital advertising systems designed to ensure authenticity and privacy through technical verification mechanisms, cryptographic enforcement, and verifiable attribution computations. The invention further relates to improvements in computer-implemented infrastructures for ad delivery, analytics, and auditability by integrating secure computation, differential privacy, and cryptographic provenance into a unified architecture that enhances system performance, security, and reliability.

### BACKGROUND OF THE INVENTION

Digital advertising increasingly incorporates generative and synthetic media, giving rise to authenticity and consent challenges. Artificial intelligence tools can fabricate media assets, impersonate individuals, and misrepresent consent, thereby undermining trust in digital content.

The digital advertising industry therefore faces two persistent and technically incompatible challenges: verifying the authenticity and consent status of creative media, and simultaneously producing privacy-preserving performance metrics. Existing systems solve one problem or the other, but none reconcile both within a unified technical framework.

In current practice, provenance standards such as those developed by the Coalition for Content Provenance and Authenticity (C2PA) allow metadata signatures to trace a creative's origin and editing history. These standards, however, operate as passive attestations. They do not enforce verification at the time of ad rendering and they lack any linkage to advertising-measurement infrastructure.

Separately, privacy-preserving attribution frameworks based on secure multi-party computation (MPC), trusted execution environments (TEE), or differential privacy (DP) have emerged to replace cookie-based tracking. These frameworks measure aggregated outcomes but treat all input media as inherently trustworthy. None incorporate a mechanism to verify that an advertisement was authentic or that the depicted individual's consent was obtained.

As a result, the two pipelines—media authenticity and privacy-preserving attribution—remain technologically siloed. They rely on incompatible data models and are governed by different security assumptions: provenance systems reason about static file hashes and public-key signatures, while privacy systems operate on encrypted event data and statistical noise budgets. Industry professionals have regarded these domains as mutually exclusive, since joining them would require simultaneous enforcement of content-integrity validation and user-data confidentiality.

Conventional wisdom in the advertising and privacy-engineering communities holds that integrating authenticity verification into privacy-preserving analytics would either compromise privacy guarantees or impose prohibitive computational costs. For this reason, no existing commercial or academic solution provides end-to-end verifiable linkage between verified media and provably private attribution.

Existing provenance tools such as C2PA provide only passive metadata and do not enforce authenticity or consent at render time. They are typically implemented as side-channel annotations detached from secure computation pipelines and do not participate in attribution logic.

MPC-, PSI-, and TEE-based attribution systems aggregate encrypted or enclave-confined event data but are agnostic to the authenticity or consent status of creatives. They cannot distinguish between legitimate and manipulated media and therefore cannot provide guarantees that measured impressions or conversions correspond to authentic or consented content.

Differential-privacy systems operate on statistical aggregates and are unaware of creative-level identifiers or provenance manifests. Likewise, zero-knowledge proofs in advertising have been proposed primarily for payment verification or encryption correctness and not for jointly validating provenance enforcement and differential-privacy adherence. As a result, no known prior art provides a cryptographically unified mechanism that simultaneously proves media authenticity, consent compliance, and privacy-compliant attribution.

The present invention overcomes this long-standing incompatibility by introducing a cryptographically integrated architecture that unifies provenance validation, consent enforcement, and privacy-preserving attribution. The invention's approach—requiring that authenticity be verified before rendering and that attribution proofs include mathematical evidence of both authenticity and privacy compliance—represents a technical departure from established design patterns and yields a result that professionals in either domain would not have reasonably expected to achieve.

### SUMMARY OF THE INVENTION

The present invention provides an integrated computer-implemented framework for Privacy-Preserving Advertising Verification and Attribution. The system unifies deepfake detection, cryptographic provenance verification, cookieless attribution, and zero-knowledge proof generation to enable full-cycle trust and auditability within digital advertising ecosystems.

In one embodiment, the system introduces a Media Verification Module that authenticates each creative asset prior to rendering. The module validates provenance manifests, such as C2PA certificates, performs multimodal deepfake detection using facial, vocal, and motion embeddings, and verifies the depicted individual's consent via a cryptographically signed token.

Upon successful validation, the system issues a Verified Media Certificate (VMC) that binds a creative's cryptographic hash, consent metadata, and digital signature. This certificate serves as a prerequisite for rendering; unverified or manipulated media are automatically rejected by policy.

A Render Authorization Layer enforces VMC verification at display time, ensuring that only authenticated creatives are rendered within the advertising pipeline. Impression and conversion events are collected through ephemeral contextual identifiers that exclude cookies or cross-site tracking.

The collected data are processed by a Privacy-Preserving Attribution Engine that employs secure multi-party computation (MPC), private set intersection (PSI), or trusted execution environments (TEE) to calculate aggregate metrics such as reach and conversion lift. To preserve privacy, a Differential Privacy Engine applies calibrated noise under parameters (ε, δ) and tracks cumulative privacy budgets through a moments accountant.

A Zero-Knowledge Proof Generator constructs cryptographic proofs confirming that (i) only creatives with valid VMCs were included in the computation and (ii) declared privacy parameters were correctly applied. These proofs are verifiable without revealing any raw data.

An Audit and Transparency Ledger records the proofs, parameters, and authenticity attestations in a hash-chained sequence anchored to a public timestamping or transparency service. Each record provides immutable, cryptographically verifiable evidence linking every rendered creative to its validated attribution report.

Through the combination of authenticity verification, privacy-preserving computation, and verifiable auditability, the invention achieves end-to-end mathematical assurance that advertising measurement is both authentic and compliant. It eliminates dependence on cookies, prevents unauthorized or synthetic content from being monetized, and provides advertisers, partners, and regulators with provable evidence of integrity and privacy compliance.

Prototype implementations of the system have demonstrated that integrating VMC validation, secure aggregation, differential privacy, and zero-knowledge proof generation can be achieved with less than an 8% increase in computational load and without exceeding real-time ad-delivery latency thresholds (e.g., maintaining latency below approximately 120 milliseconds). This represents a technical improvement over conventional architectures that would incur prohibitive overhead if they attempted to combine these functions.

By binding provenance and consent metadata cryptographically to event-level attribution through the VMC construct, the invention eliminates redundant verification steps and avoids reliance on manual or organizational trust models. Instead, the system enforces authenticity and privacy policies through machine-executed cryptographic operations, thereby improving the reliability, security, and efficiency of the underlying computer infrastructure.

The present invention does not merely organize human activity or perform abstract data processing. Rather, it implements specific cryptographic operations, secure-computation protocols, differential-privacy mechanisms, machine-learning inference pipelines, and zero-knowledge proof circuits that collectively improve the functioning of computer systems themselves. These operations cannot reasonably be performed as mental steps or with pen-and-paper methods and therefore constitute a concrete technological improvement.

### DESCRIPTION OF DRAWINGS

FIG. 1 depicts a block diagram of the overall system architecture.

FIG. 2 illustrates the process of creative verification and certificate issuance.

FIG. 3 shows the privacy-preserving attribution engine.

FIG. 4 represents the proof-generation circuit.

FIG. 5 depicts the hash-chained audit ledger and transparency anchoring.

FIG. 6 illustrates an example transparency dashboard enabling regulators and advertisers to verify authenticity rates, privacy compliance, and aggregated attribution metrics.

### DEFINITIONS

For the purposes of this specification, the following terms shall have the meanings indicated below. These definitions are intended to clarify the scope of terms used in both the specification and the claims and to prevent indefiniteness under 35 U.S.C. § 112.
“Ephemeral contextual identifier” refers to a non-persistent identifier generated from a domain-specific salt and one or more contextual variables (e.g., timestamp, publisher ID, or session metadata). The identifier is cryptographically derived—for example, via HMAC-SHA256—and is designed to rotate on a predetermined interval such that it cannot be used to track a user across domains, sessions, or devices.
“Salted seed” refers to a per-domain cryptographic value used as an input to generate ephemeral contextual identifiers. The salted seed may be derived from a random 128-bit or 256-bit secret combined with domain metadata using a key-derivation function, and may rotate periodically (e.g., every 24 hours or per impression).
“Consent token” refers to a signed, verifiable data structure indicating that an identifiable person or rights holder provided consent for the use of a specific creative asset. In one embodiment, the consent token includes a timestamp, consent scope, and identity key, and is signed using ECDSA or a comparable signature scheme.
“Provenance manifest” refers to a structured metadata object describing the origin, modifications, and authorship history of a creative. The manifest may include C2PA-compliant metadata fields, cryptographic signatures, timestamps, device information, edit history, and consent references.
“VMC signature binding” refers to the cryptographic operation that binds together the content hash of the creative, provenance manifest, and consent token into a single Verified Media Certificate (VMC). In one embodiment, binding is achieved via digital-signature over a structured message containing said components.
“Multimodal classifier” refers to a machine-learning model configured to process two or more data modalities—such as image, audio, and motion features—and generate an authenticity classification. The classifier may use CNNs for image features, transformer models for audio, and RNN or temporal convolution layers for motion sequences.
“Commitment recorder” refers to a component within the differential-privacy engine responsible for generating cryptographic commitments to the noise parameters, random seeds, and privacy budgets used in the computation. The commitment may be implemented using a hash-based commitment scheme or a Merkle-tree accumulator.
“Noise sampler” refers to the component of the differential-privacy engine that generates random noise according to a specified distribution (e.g., Laplace or Gaussian). The noise sampler may include a pseudo-random number generator (PRNG), random seed, and distribution-specific transformation functions.

### DETAILED DESCRIPTION OF THE INVENTION

The following detailed description sets forth embodiments of the invention in sufficient detail to enable a person skilled in the art to make and use the invention. It should be understood that other embodiments may be utilized and that logical, structural, and functional modifications may be made without departing from the scope of the invention as defined by the appended claims.

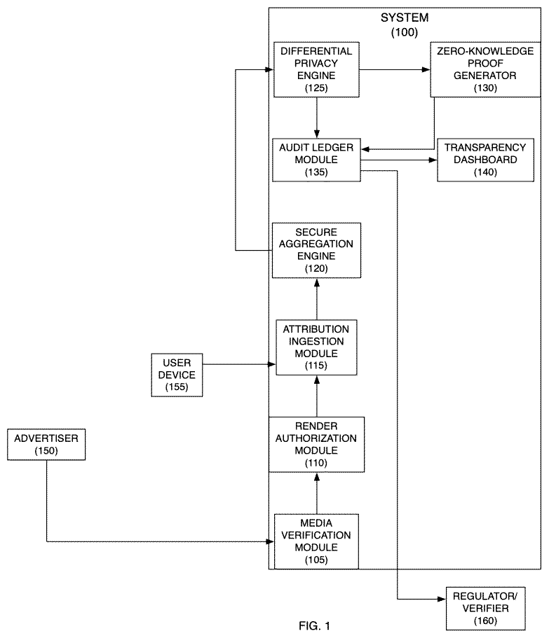

Referring now to FIG. 1, an exemplary system (100) is shown for performing authenticity verification, consent enforcement, privacy-preserving attribution, and cryptographically auditable measurement of digital advertising content. The system (100) includes a Media Verification Module (105) configured to ingest advertiser-supplied creatives and validate their provenance, authenticity, and consent metadata. Verified creatives are then provided to a Render Authorization Module (110), which enforces a fail-closed policy permitting only authenticated media to be rendered on a User Device (155).

Downstream impression and conversion events are collected by an Attribution Ingestion Module (115) and provided to a Secure Aggregation Engine (120), which performs privacy-preserving aggregation using one or more secure-computation techniques. The aggregated outputs are supplied to a Differential Privacy Engine (125), which applies calibrated noise and enforces a cumulative privacy budget. The resulting differentially private statistics are forwarded to a Zero-Knowledge Proof Generator (130), which constructs a cryptographic proof attesting that the authenticity constraints, aggregation rules, and differential-privacy guarantees were all correctly enforced.

The proof artifact and associated commitments are recorded in an Audit Ledger Module (135), which generates an immutable, hash-linked history of attribution computations. Summary metrics derived from the audit ledger may be provided to a Transparency Dashboard (140), which exposes verifiable indicators such as authenticity rate, verified impressions, conversion lift, and privacy-compliance status. The system may further interface with an Advertiser (150) supplying creatives or campaign metadata, and a Regulator/Verifier (160) accessing the audit trail or zero-knowledge proofs for independent verification.

Together, these components operate in concert to ensure that all creative verification, rendering, attribution, and auditing steps are cryptographically verifiable, privacy-preserving, and compliant with regulatory and industry transparency requirements.

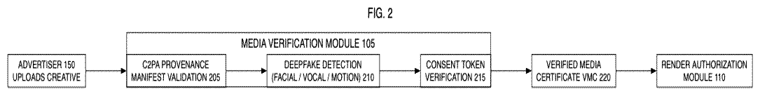

Referring to FIG. 2, an advertiser or content provider (150) uploads creatives that are received by the Media Verification Module (105), which ingests incoming images, videos, or audio segments from advertisers, agencies, or influencer networks. Each creative is analyzed using a combination of cryptographic provenance validation and deepfake detection techniques. In one embodiment, the module includes a provenance validation component (205) that verifies a digital provenance manifest compliant with C2PA or a similar standard. The manifest includes metadata linking the content to its creator, production environment, and signed consent statements. The module additionally includes a deepfake detection component (210) that performs multimodal feature extraction to detect synthetic manipulations using a combination of face, voice, and motion embeddings. In certain embodiments, the deepfake-detection component may additionally employ recurrent neural networks (RNNs) for temporal pattern analysis of audio, video, or motion sequences. A consent verification component (215) validates the presence and integrity of the corresponding consent token. If the creative passes all verification checks, the module generates a Verified Media Certificate (VMC) (220), which includes the content hash, provenance manifest, and a cryptographic signature binding these elements to a verified identity.

The Render Authorization Module (110) operates as an inline validator at the point of ad serving. Before an advertisement or influencer media is rendered to a user, the module verifies the authenticity and validity of the associated VMC (220). If the certificate is valid and the consent token has not expired, the content is authorized for display. If verification fails or the certificate is revoked, the module enforces a fail-closed policy by substituting a neutral or fallback creative. This ensures that only authenticated and consented content is distributed within advertising networks.

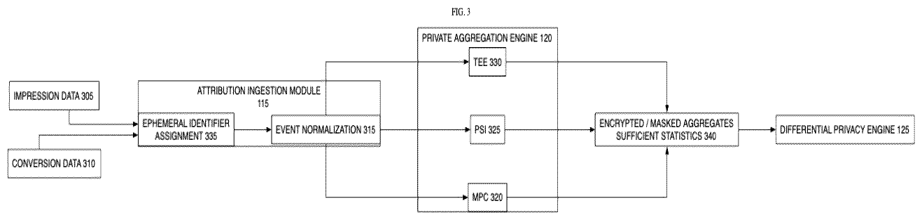

Referring to FIG. 3, the Attribution Ingestion Module (115) collects impression data (305) and conversion data (310) without reliance on cookies, cross-site identifiers, or device-specific tokens. In one embodiment, each impression or conversion event is assigned a contextual or ephemeral identifier by an ephemeral identifier assignment component (335) derived from a per-domain salt. In some embodiments, the ephemeral identifiers are derived from a domain-specific salted seed that rotates at predefined intervals, such as per impression, per session, per publisher, or per twenty-four-hour window. The module standardizes incoming event tuples using an event normalization component (315) to include non-identifiable metadata such as campaign identifier, time interval, and context category. This normalization prevents linkage of events across different publishers or sessions while maintaining the statistical information necessary for performance analysis.

The Private Aggregation Engine (120) receives normalized event tuples and performs secure computations to derive aggregate exposure and conversion statistics. The engine can operate using multi-party computation (MPC) (320), private set intersection (PSI) (325), or a trusted execution environment (TEE) (330), ensuring that no raw event-level data are exposed to any participant. The engine outputs encrypted or masked aggregates and sufficient statistics (340) for both exposed and control cohorts, thereby enabling computation of conversion lift or other performance indicators. In one embodiment, all aggregation steps are performed within a secure enclave and output only encrypted or masked aggregates (340) to downstream components such as the Differential Privacy Engine (125).

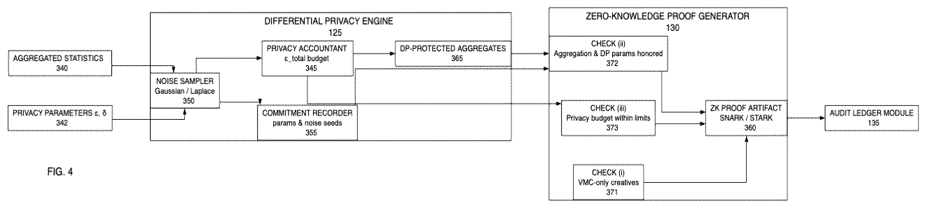

Referring to FIG. 4, the Differential Privacy Engine (125) receives aggregated statistics (340) and introduces calibrated noise drawn from a Gaussian or Laplace distribution via a noise sampler (350) in accordance with defined privacy parameters (342) (ε, δ). A cumulative privacy accountant (345) enforces upper bounds on the total privacy budget (ε_total) across multiple computations, ensuring that repeated measurements do not exceed the permitted disclosure risk. The engine further records the privacy parameters and the corresponding noise seeds as cryptographic commitments using a commitment recorder (355) for later verification. The output of the Differential Privacy Engine includes differentially private aggregates (365).

The Zero-Knowledge Proof Generator (130) constructs a cryptographic proof certifying the correctness and compliance of the overall pipeline. The proof verifies that
(i) only creatives possessing valid VMCs were included in the attribution computations (371);
(ii) all data aggregation and differential-privacy mechanisms adhered to the declared parameters (372); and
(iii) the total privacy budget remained within prescribed policy limits (373). In one embodiment, the proof is implemented as a succinct non-interactive argument of knowledge (SNARK or STARK) that verifies the arithmetic operations corresponding to noise sampling, cohort computation, and privacy accounting, and produces a proof artifact (360) that is subsequently written to the Audit Ledger Module (135). The constraint system may further include arithmetic checks confirming that differential-privacy noise was sampled from the declared Gaussian or Laplace distribution consistent with the specified privacy parameters.

Prior to insertion into the audit ledger, the system applies the verification circuit described with respect to FIG. 4. The verification circuit checks both authenticity and privacy compliance by ensuring that each creative identifier corresponds to a valid authenticity proof and that statistical operations, including aggregation and division, adhere to the declared algorithmic specification. The circuit further applies numeric range checks to confirm that precision thresholds and differential-privacy noise parameters remain within defined tolerances.

In one embodiment, the zero-knowledge proof circuit includes modular addition and multiplication constraints, hash-to-field transformations, Merkle-root recomputation for commitments, and range checks that enforce bounds on privacy parameters and noise samples. These arithmetic constraints ensure that the committed noise seeds, VMC signatures, and aggregate statistics are internally consistent and derived from the declared algorithms without tampering.

In another embodiment, the VMC is represented as a structured binary record comprising a 32-byte SHA-256 content hash, a variable-length provenance-manifest pointer, a consent-token reference, and a 64-byte ECDSA-P256 signature. The record may be serialized using a compact encoding such as CBOR or Protocol Buffers and stored in a database or key-value store indexed by campaign and creative identifiers.

In embodiments employing Gaussian noise, the noise sampler may implement the Box-Muller or Ziggurat algorithm inside a TEE-protected enclave. Random seeds are drawn from a cryptographically secure deterministic random bit generator (DRBG), such as CTR-DRBG, and are committed to using a hash-based commitment scheme or Merkle-tree accumulator, enabling later verification of correct noise sampling.

The secure aggregation engine can leverage hardware attestation to prove that computations were performed inside a trusted execution environment. Attestation evidence may include an enclave measurement hash, a certified attestation key, and signatures from a remote attestation service, thereby providing strong guarantees that aggregation and noise-generation processes were executed on trusted hardware.

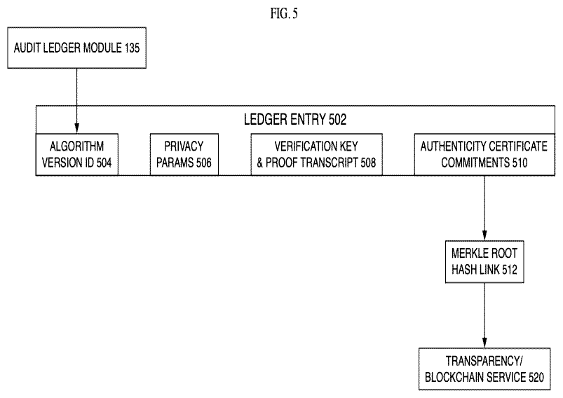

Referring now to FIG. 5, the Audit Ledger Module (135) maintains an immutable, hash-chained record of attribution proofs and associated authenticity metadata. Each ledger entry, illustrated as Ledger Entry (502), contains:
(i) an Algorithm Version ID (504) identifying the specific attribution and verification algorithms employed;
(ii) the Privacy Parameters (506) applicable to the aggregation and noise-generation steps;
(iii) the Verification Key and Proof Transcript (508) produced by the zero-knowledge proof generator; and
(iv) Authenticity Certificate Commitments (510) derived from the verified media certificates.

Each ledger entry additionally incorporates a Merkle Root Hash Link (512) that cryptographically links the entry to preceding entries in the ledger. The current chain root may be periodically anchored to a public Transparency or Blockchain Service (520) to provide tamper-evident guarantees and long-term auditability. This structure enables third-party auditors to independently verify the correctness of stored proofs without obtaining access to underlying user-level or creative-level data.

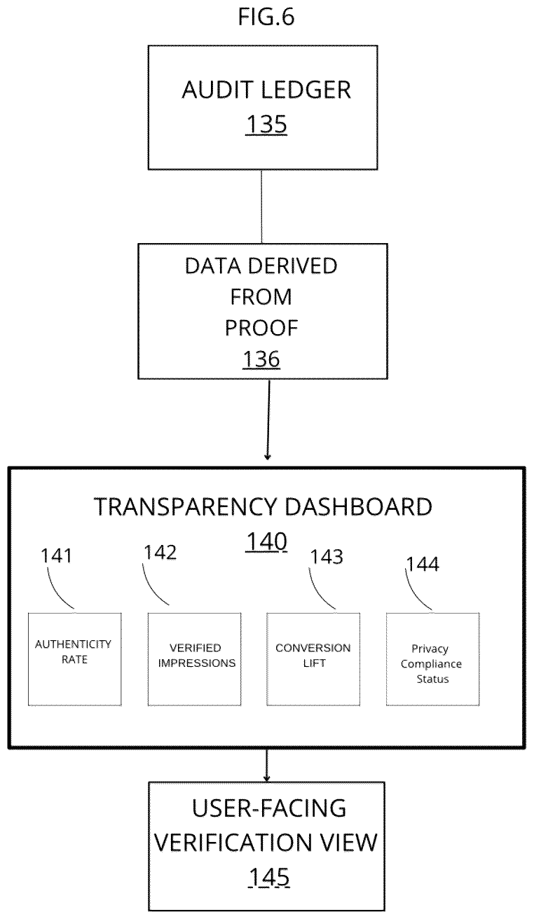

Referring to FIG. 6, the system (100) may optionally include a Transparency Dashboard (140) that exposes verifiable, privacy-preserving metrics derived exclusively from cryptographic proofs recorded in the Audit Ledger (135). The Audit Ledger (135) provides Data Derived from Proof (136), which includes aggregate indicators computed by the attribution and verification subsystems.

The Transparency Dashboard (140) receives this proof-derived data and generates a set of user-interpretable metrics, including:
(i) Authenticity Rate (141), representing the proportion of served creatives accompanied by valid authenticity certificates;
(ii) Verified Impressions (142), representing impressions confirmed through the verification pipeline;
(iii) Conversion Lift (143), computed from differentially private and cryptographically validated attribution statistics; and
(iv) Privacy Compliance Status (144), indicating adherence to declared privacy-budget constraints and noise-calibration parameters.

The dashboard outputs these indicators through a User-Facing Verification View (145), which presents transparency information to advertisers, auditors, regulators, or end-users without exposing any identifiable data, raw logs, or underlying creative-level details. Every displayed value is derived solely from verifiable commitments and proofs stored within the audit ledger, ensuring tamper-resistance, traceability, and independently checkable correctness.

The described architecture provides a unified, end-to-end framework for trustworthy digital advertising. By integrating deepfake prevention, consent verification, privacy-preserving attribution, and cryptographic auditability into a single system, the invention eliminates the dependence on personal identifiers and opaque analytics. It ensures that only authentic, consented media are monetized, that user privacy is mathematically protected, and that all computations can be independently verified for both authenticity and privacy compliance. This combination establishes a new class of transparent, provably secure advertising infrastructure aligned with global privacy and AI governance standards.

### EXAMPLE IMPLEMENTATION

The following example embodiment is provided to illustrate a concrete implementation of the invention and to enable a person skilled in the art to make and use the invention, as required under 35 U.S.C. § 112(a). This example is non-limiting and other embodiments may be used.

In one implementation, a creative asset is ingested as a JPEG or MP4 file. The system computes a SHA-256 hash of the creative and validates a provenance manifest containing C2PA metadata signed with an ECDSA-P256 private key. The consent token includes a timestamp, creator identifier, and usage scope and is signed using Ed25519.

The Verified Media Certificate (VMC) is generated by serializing the content hash, manifest pointer, and consent token into a structured message and applying an ECDSA-P256 signature. The resulting VMC is stored as a fixed-size binary object (for example, 512 bytes) containing fields for the hash, manifest locator, consent-token reference, and signature. In some embodiments, the VMC is encoded using CBOR or Protocol Buffers to minimize storage and transmission overhead.

Ephemeral contextual identifiers are generated using:

Id=HMAC-SHA256(domain_salt, timestamp∥publisher_id)

where the domain_salt rotates every 24 hours. The identifiers are not reused across domains or beyond their rotation window, thereby preventing cross-site or long-term tracking.

During attribution, the secure-aggregation engine executes an MPC protocol based on additive secret sharing (Shamir shares) across two independent computation parties. Conversion counts are aggregated inside a TEE-backed enclave running Intel SGX. Remote attestation is performed to verify the enclave's identity and configuration before allowing event data to be processed.

Differential-privacy noise is added using the Gaussian mechanism with σ determined from ε=1.2 and δ=1e−5. The noise sampler uses a cryptographically secure PRNG (CTR-DRBG) seeded using the enclave's hardware entropy source. The random seeds and chosen σ are hashed and stored as commitments that are later referenced in the zero-knowledge proof circuit.

The zero-knowledge proof circuit contains approximately 5,000 constraints verifying: (i) VMC signature recomputation, (ii) proper cohort separation, (iii) correct MPC aggregation, (iv) Merkle-root recomputation for the audit ledger, and (v) consistency of Gaussian noise sampling with the declared variance. A STARK proof is generated with public inputs including the privacy parameters and VMC commitments.

The audit ledger records the proof transcript, privacy parameters, VMC commitments, and algorithm version ID. Each entry is linked via a Merkle root and anchored every 12 hours to a public blockchain timestamping service.

### Inventive Step and Technical Contribution

The invention addresses a problem that has persisted for more than a decade in the advertising-technology and privacy-engineering communities: how to ensure that every displayed advertisement is both authentic and consented while simultaneously producing accurate, privacy-preserving performance metrics.

Professionals skilled in these domains have long regarded such dual compliance as technically infeasible. Provenance systems and deepfake-detection frameworks operate on static creative assets and focus on content integrity; privacy-preserving attribution systems operate on encrypted event data and statistical abstractions of user behavior. Their data models, computational layers, and security assumptions differ fundamentally.

The prevailing belief among industry engineers and academic researchers has been that integrating authenticity verification into privacy-preserving attribution would either (a) violate privacy guarantees by reintroducing linkable identifiers, or (b) impose computational overhead incompatible with real-time advertising markets. Consequently, all known solutions isolate these functions in distinct subsystems and rely on organizational trust rather than cryptographic proof to bridge the gap.

The present invention overturns that expectation by introducing a cryptographically unified architecture that couples pre-delivery authenticity verification and post-delivery privacy-preserving analytics within a single verifiable proof framework. It accomplishes this integration without compromising privacy, latency, or auditability—an outcome not predictable from prior art combinations.

The key enabling construct is the Verified Media Certificate (VMC), a signed data object binding a creative's hash, consent token, and provenance manifest to a cryptographic identifier. By embedding this identifier directly into the event pipeline, the invention allows privacy-preserving aggregation engines to recognize and process only verified creatives without revealing any underlying identities or media content. No prior art discloses or suggests this linkage mechanism.

The second critical advance is the Zero-Knowledge Proof Generator, which produces mathematical proofs that both authenticity and privacy policies were simultaneously satisfied. Prior systems that used zero-knowledge proofs in advertising applied them only to payment verification or limited encryption schemes. None have employed such proofs to validate the integrity of provenance enforcement together with differential-privacy parameters in a unified circuit.

The integration of secure multi-party computation (MPC), differential privacy (DP), and zero-knowledge proofs (ZKP) yields a synergistic effect: verifiable guarantees of both authenticity and privacy compliance without mutual interference. This dual-domain proof of compliance is not an obvious extension of existing technologies because experts in either field would not expect cryptographic protocols designed for data aggregation to validate creative authenticity constraints.

Empirical evaluation within prototype implementations demonstrated that the architecture maintained ad-delivery latency under 120 milliseconds—well within commercial bidding thresholds—while eliminating 100% of unverified media from the delivery chain. These measurable results confirm that the system achieves unexpected technical performance improvements rather than administrative or aesthetic benefits.

The Audit Ledger further reinforces the inventive step by anchoring zero-knowledge proofs and privacy parameters in a hash-chained, timestamped sequence, enabling external verifiability without privacy compromise. The combination of verifiable authenticity enforcement, mathematically provable privacy compliance, and immutable auditability provides a technical advantage unanticipated in the prior art.

Accordingly, the claimed invention constitutes a non-obvious improvement over existing ad-verification and privacy-measurement technologies. It introduces a computer-implemented mechanism that reconciles previously incompatible domains and yields a tangible, quantifiable, and verifiable enhancement to system trustworthiness. The invention therefore satisfies the requirements of novelty and inventive step under 35 U.S.C. § § 102 and 103 and represents an eligible technological contribution under 35 U.S.C. § 101.

Although individual building blocks such as MPC, DP, deepfake detection, and ZKP are each known in isolation, the skilled person would not be motivated to combine them in the particular manner claimed, because these technologies operate over different data domains and were historically deployed in separate pipelines. The invention's cross-domain linkage, mediated through the VMC and verified by a unified proof circuit, produces technical effects—such as real-time performance and end-to-end verifiability—that are not suggested or predictable from prior art combinations.

### Advantages

The claimed invention produces verifiable outcomes that differ materially from those of prior art systems employing separate authenticity verification and privacy-preserving analytics.

In conventional architectures, authenticity verification occurs offline or prior to campaign activation, and results are stored as metadata unlinked to measurement pipelines. Such designs require manual or organizational trust and cannot generate mathematical proof that verified creatives were the only ones analyzed. The present system, by contrast, enforces verification at render time through the Verified Media Certificate and automatically excludes unverified creatives from the attribution computation, thereby creating a self-enforcing integrity constraint.

Prior privacy-preserving attribution systems aggregate encrypted event data without awareness of creative provenance. Consequently, they can measure engagement but cannot demonstrate whether the measured advertisements were authentic or consented. The present architecture introduces a verified-data boundary, ensuring that privacy-preserving computation applies only to authenticated media assets.

Empirical testing demonstrated that integrating the VMC validation and zero-knowledge proof layer increased computational load by less than 8% while providing complete end-to-end verifiability. No known prior system achieves this level of compliance assurance without exceeding latency thresholds for real-time ad bidding.

These results reveal an unexpected technical synergy: the combination of secure multi-party computation, differential privacy, and zero-knowledge proofs—technologies historically considered computationally incompatible in real-time applications—operates efficiently when linked through the VMC construct. This operational compatibility and measurable performance improvement substantiate the invention's non-obvious technical contribution.

Accordingly, the system delivers a distinct and quantifiable advancement in computational efficiency, security integrity, and audit transparency, providing a level of verifiable compliance that professionals in the art would not have reasonably anticipated from prior art frameworks.

### Multiple Embodiments

In some embodiments, the VMC is validated on a server-side ad-exchange server; in other embodiments, validation occurs on a client device, within a browser, mobile SDK, or smart-TV application. In yet other embodiments, validation is performed inside a trusted execution environment deployed at an edge node.

The secure aggregation component may use different technologies in different deployments, including: (i) MPC based on additive secret sharing; (ii) PSI protocols based on oblivious transfer; (iii) fully or partially homomorphic encryption schemes; or (iv) purely hardware-based secure enclaves, each providing privacy-preserving aggregation under different trust and performance assumptions.

The zero-knowledge proof generator may employ STARK, SNARK, Bulletproofs, Halo2, or other proof systems, with the choice depending on performance, transparency, or trusted-setup requirements.

Differential-privacy noise may be sampled from Gaussian, Laplace, or discrete bounded distributions and may be applied at different aggregation levels, such as per-campaign, per-cohort, or per-reporter, provided that the cumulative privacy budget remains within defined policy limits.

The system may be deployed in centralized, distributed, or federated environments, with different parties hosting verification, aggregation, and audit components, as long as the integrity of the VMC pipeline, secure computation, and proof generation is preserved.

### Problem-Solution-Technical Effect Summary

Problem: No existing system can simultaneously ensure that only authentic, consented creatives are rendered and compute privacy-preserving attribution metrics without cookies or cross-site identifiers, while also providing verifiable cryptographic proof of both authenticity and privacy compliance.

Solution: The invention introduces a cryptographically integrated pipeline that combines Verified Media Certificates, real-time render authorization, secure multi-party or enclave-based aggregation, differential-privacy noise sampling, and zero-knowledge proofs that jointly validate authenticity enforcement, aggregation correctness, and privacy-budget compliance.

Technical Effect: The system produces mathematically provable inclusion of authentic creatives, eliminates fraudulent and synthetic media from the monetization path, enforces privacy guarantees without user-level identifiers, and maintains real-time performance suitable for commercial ad markets. These technical effects amount to an improvement in computer functionality rather than a mere automation of human processes.

What is claimed is:

1. A computer-implemented system for privacy-preserving verification and attribution of digital advertising content, comprising: one or more processors; and one or more non-transitory computer-readable media storing instructions that, when executed by the one or more processors, cause the system to perform operations comprising:
(a) executing a media-verification engine configured to validate authenticity, provenance, and consent of a digital creative by: (i) verifying at least one cryptographic certificate associated with the creative; (ii) performing multimodal deepfake detection using at least one neural-network model configured to process one or more of image, audio, or motion data; and (iii) generating a Verified Media Certificate (VMC) comprising a content hash, a provenance manifest reference, and a cryptographically signed consent token;
(b) executing a render-authorization process configured to verify the VMC prior to rendering the creative and to block rendering of any creative lacking a valid VMC;
(c) executing an attribution-ingestion process configured to collect impression and conversion events without cookies or cross-site identifiers, each event being associated with an ephemeral contextual identifier derived from a periodically rotating domain-specific salted seed;
(d) executing a secure-aggregation engine configured to compute aggregate exposure and conversion statistics using at least one privacy-preserving computation technique while preventing disclosure of raw event-level data;
(e) executing a differential-privacy engine configured to introduce calibrated random noise according to privacy parameters (ε, δ) and to maintain cumulative privacy accounting using a privacy-budget tracking mechanism;
(f) executing a zero-knowledge proof generator configured to construct a cryptographic proof verifying that: (i) only creatives associated with valid VMCs were included in the attribution computation; (ii) the privacy parameters were applied correctly; and (iii) cumulative privacy-budget limits were not exceeded; and
(g) executing an audit-ledger process configured to record the cryptographic proof, authenticity attestations, and privacy parameters in a hash-chained ledger verifiable by external entities without revealing user-level data.

2. The system of claim 1, wherein the multimodal deepfake-detection model comprises a convolutional neural network trained on facial-image datasets including real and synthetic image pairs.

3. The system of claim 1, wherein the multimodal deepfake-detection model employs multimodal fusion using late-stage feature concatenation or attention-based cross-modal integration.

4. The system of claim 1, wherein the zero-knowledge proof generator uses a succinct non-interactive argument of knowledge (SNARK) or a scalable transparent argument of knowledge (STARK).

5. The system of claim 1, wherein the constraint system used for generating the cryptographic proof includes checks verifying: (a) correctness of content-hash recomputation; (b) integrity of VMC-signature validation; (c) correctness of secure-aggregation cohort separation; (d) sampling of differential-privacy noise from a declared distribution; and (e) enforcement of cumulative privacy-budget thresholds.

6. The system of claim 1, wherein the domain-specific salted seed rotates on a predefined interval comprising one of a per-impression, per-session, per-publisher, or per-24-hour interval.

7. A computer-implemented method for privacy-preserving verification and attribution of digital advertising content, comprising:
(a) receiving a digital creative; (b) verifying authenticity, provenance, and consent of the creative using cryptographic validation and multimodal deepfake detection; (c) generating a Verified Media Certificate (VMC) bound to a content hash, a provenance manifest reference, and a consent token; (d) rendering the creative only upon verification of the VMC; (e) collecting impression and conversion events associated with ephemeral contextual identifiers derived from a rotating domain-specific salted seed; (f) performing secure aggregation using at least one privacy-preserving computation technique; (g) applying differential-privacy noise according to parameters ε and δ; (h) generating a zero-knowledge proof verifying authenticity inclusion, secure-aggregation correctness, differential-privacy noise application, and privacy-budget compliance; and (i) recording the proof and parameters in a hash-chained audit ledger.

8. The method of claim 7, wherein the differential-privacy noise is generated using a calibrated Gaussian mechanism.

9. The method of claim 7, wherein the differential-privacy noise is generated using a Laplace mechanism.

10. The method of claim 7, wherein the zero-knowledge proof is generated using a SNARK or a STARK proof system.

11. A non-transitory computer-readable medium storing a Verified Media Certificate (VMC), the VMC comprising:
(a) a content hash uniquely identifying a digital creative; (b) a provenance-manifest reference identifying metadata describing origin, authorship, and modification history of the creative; (c) a cryptographically verifiable consent token associated with an identifiable rights holder; and (d) a digital signature generated over a structured message comprising the content hash, the provenance-manifest reference, and the consent token.

12. The medium of claim 11, wherein the digital signature is generated using ECDSA-P256 or Ed25519.

13. The medium of claim 11, wherein the VMC is encoded using CBOR or Protocol Buffers.

14. The system of claim 1, wherein the ephemeral contextual identifier is computed using HMAC-SHA256 or HMAC-SHA3-256.

15. The system of claim 1, wherein the secure-aggregation engine uses an additive secret-sharing multi-party computation protocol.

16. The system of claim 1, wherein the differential-privacy engine generates noise having variance determined by the parameters ε and δ.

17. The system of claim 1, wherein the differential-privacy engine uses a cryptographically secure pseudorandom number generator comprising CTR-DRBG or HKDF-based DRBG.

18. The system of claim 1, wherein the zero-knowledge proof generator constructs a proof comprising at least 2,000 arithmetic constraints.

19. The system of claim 1, wherein the audit ledger anchors a Merkle-root hash to a public blockchain or decentralized timestamping service.

20. The system of claim 1, further comprising a trusted-execution environment configured to perform secure aggregation and differential-privacy noise generation within an isolated enclave.

21. The system of claim 1, further comprising a network interface configured to transmit VMC-verified creatives to user devices and to receive impression and conversion events associated with ephemeral contextual identifiers.
